(19) United States
(12) Patent Application Publication
(10) Pub. No.: US 2012/0227636 A1
(43) Pub. Date: Sep. 13, 2012

(54) TRIPOD STAND

(76) Inventors: Kyle Meadows, Keller, TX (US); Kevin Kuykendall, Trophy Club, TX (US); Greg H. Parker, Dalas, TX (US); Allen Donald Gollott, JR., Missouri City, TX (US); Philip E. Smid, Tempe, AZ (US)

(21) Appl. No.: 13/416,806

(22) Filed: Mar. 9, 2012

Related U.S. Application Data
(60) Provisional application No. 61/451,862, filed on Mar. 11, 2011.
(60) Provisional application No. 61/479,686, filed on Apr. 27, 2011.
(60) Provisional application No. 61/492,084, filed on Jun. 1, 2011.
(60) Provisional application No. 61/582,718, filed on Jan. 3, 2012.
(60) Provisional application No. 61/600,883, filed on Feb. 20, 2012.

(51) Int. Cl. F16M 13/02

(52) U.S. Cl. 108/28; 108/150

(57) ABSTRACT

One aspect provides a stand for use with a tripod. The stand, in one embodiment, includes a first surface, and a second surface coupleable to the first surface at an angle (θ) of greater than ninety degrees. The second surface, in this embodiment, includes an opening therein configured to accept a neck of a tripod.

### CROSS-REFERENCE TO RELATED APPLICATION

This application claims the benefit of U.S. Provisional Application Ser. Nos. 61/451,862 filed on Mar. 11, 2011, 61/479,686 filed on Apr. 27, 2011, 61/492,084 filed on Jun. 1, 2011, 61/582,718 filed on Jan. 3, 2012 and 61/600,883 filed on Feb. 20, 2012 entitled “TRIPAD,” to Kyle Meadows, et al., commonly assigned with this application and incorporated herein by reference

### TECHNICAL FIELD

This application is directed, in general, to a stand and, more specifically, to a stand configured to attach to a tripod or other similar device.

### BACKGROUND

Photographers and videographers, among others, often employ tripods to support and stabilize their photography and videography equipment. While tripods are generally configured to support and stabilize the photography and videography equipment, such tripods are not configured to support other desirable items, including other electronic equipment, books, beverages, etc. What is needed in the art is a device, which may be integral to or attached to a tripod, which solves the aforementioned disadvantages.

### SUMMARY

One aspect provides a stand for use with a tripod. The stand, in one embodiment, includes a first surface, and a second surface coupleable to the first surface at an angle (θ) of greater than ninety degrees. The second surface, in this embodiment, includes an opening therein configured to accept a neck of a tripod.

Another aspect provides an alternative stand for use with a tripod. This stand, in one embodiment, includes a first surface and a second surface. The second surface, in this embodiment, has a first portion and a second portion angled from one another by an angle (Ω) of greater than ninety degrees. In this embodiment, the first portion is coupleable to the first surface by an angle (θ) of greater than ninety degrees.

### BRIEF DESCRIPTION

Reference is now made to the following descriptions taken in conjunction with the accompanying drawings, in which:

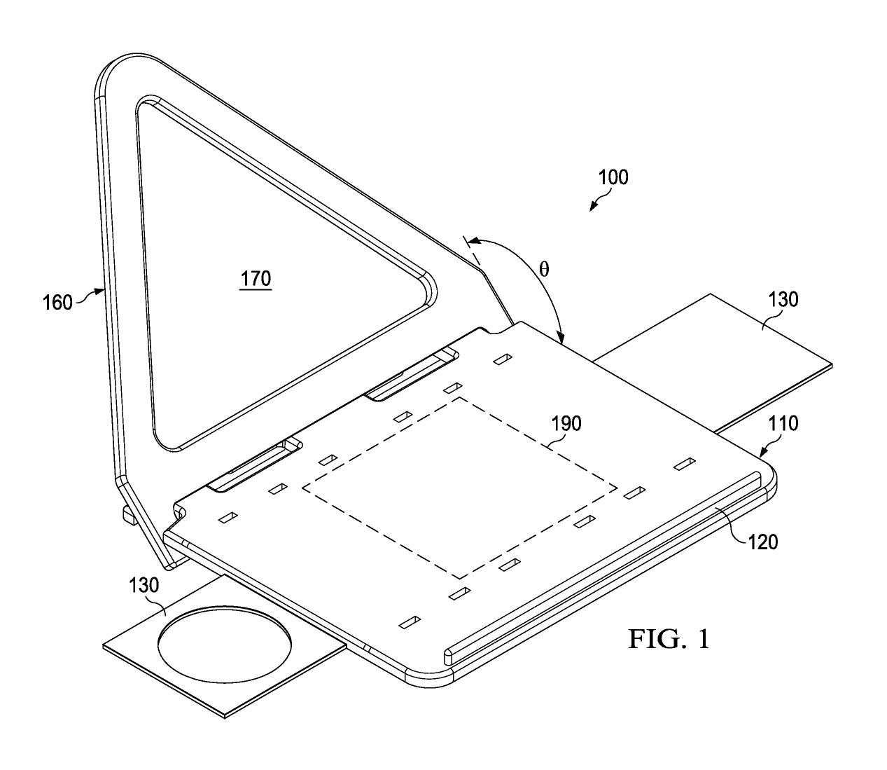

FIG. 1 illustrates one embodiment of a stand for use with a tripod;

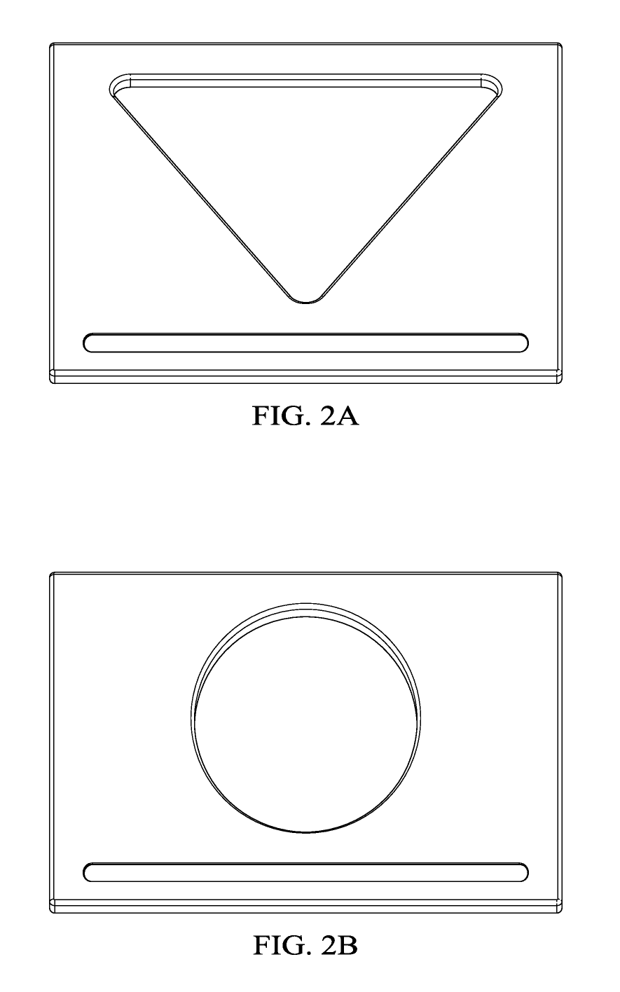

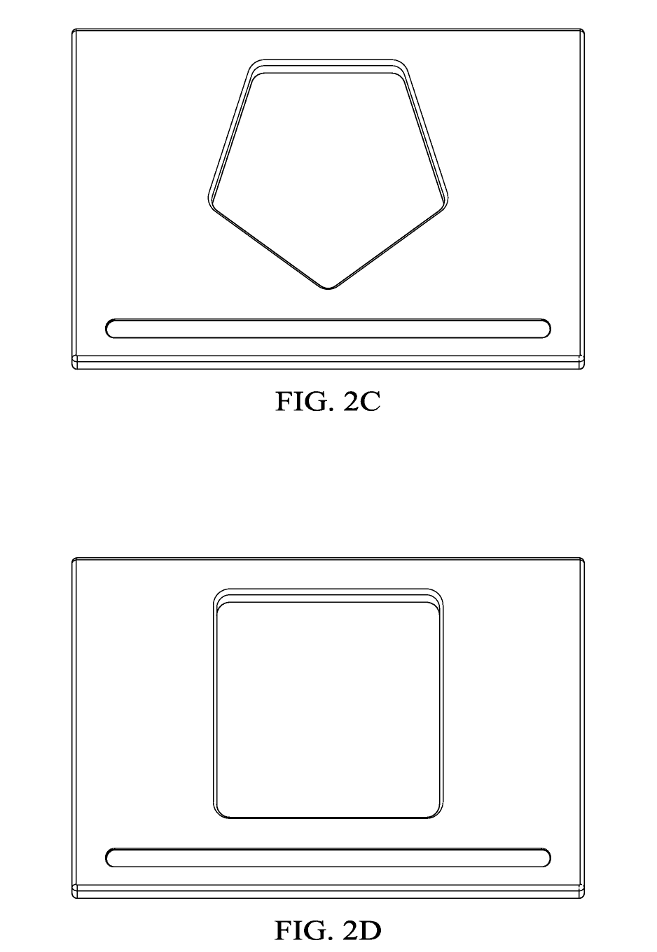

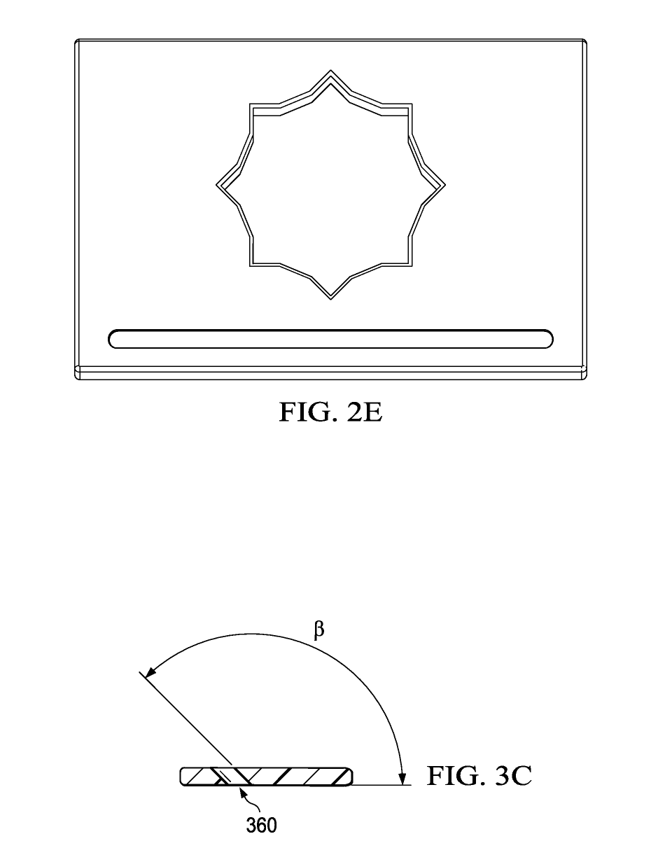

FIGS. 2A thru 2E illustrate different shapes for the opening of the stand;

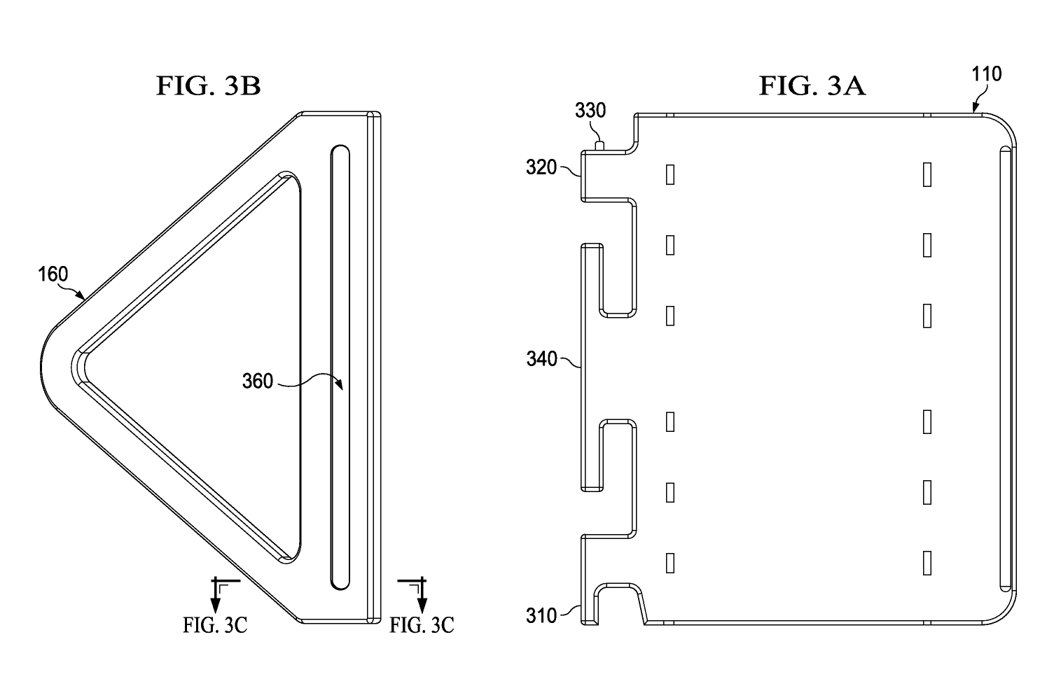

FIGS. 3A thru 3C illustrate different views of the first and second surfaces of the stand;

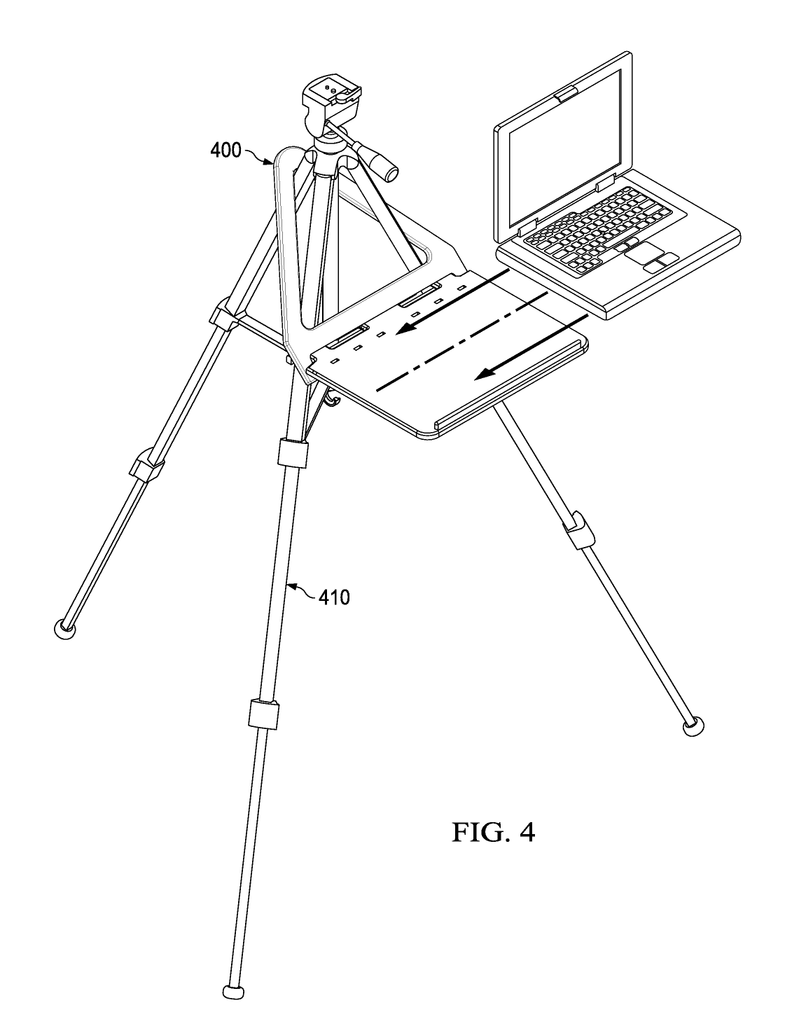

FIG. 4 illustrates a stand attached to a tripod;

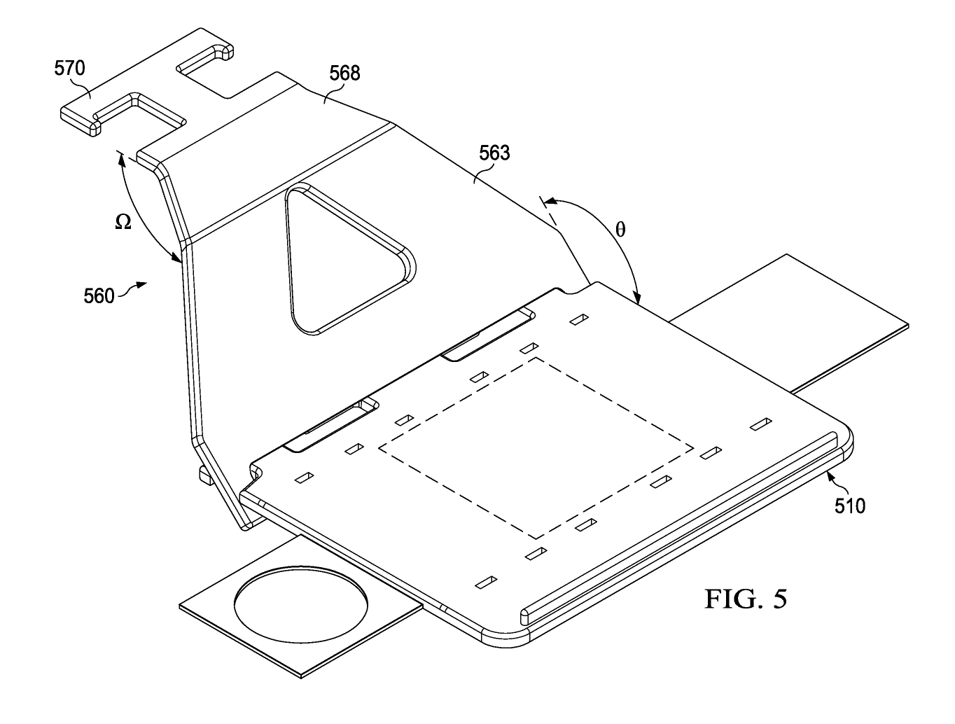

FIG. 5 illustrates an alternative embodiment of a stand for use with a tripod; and

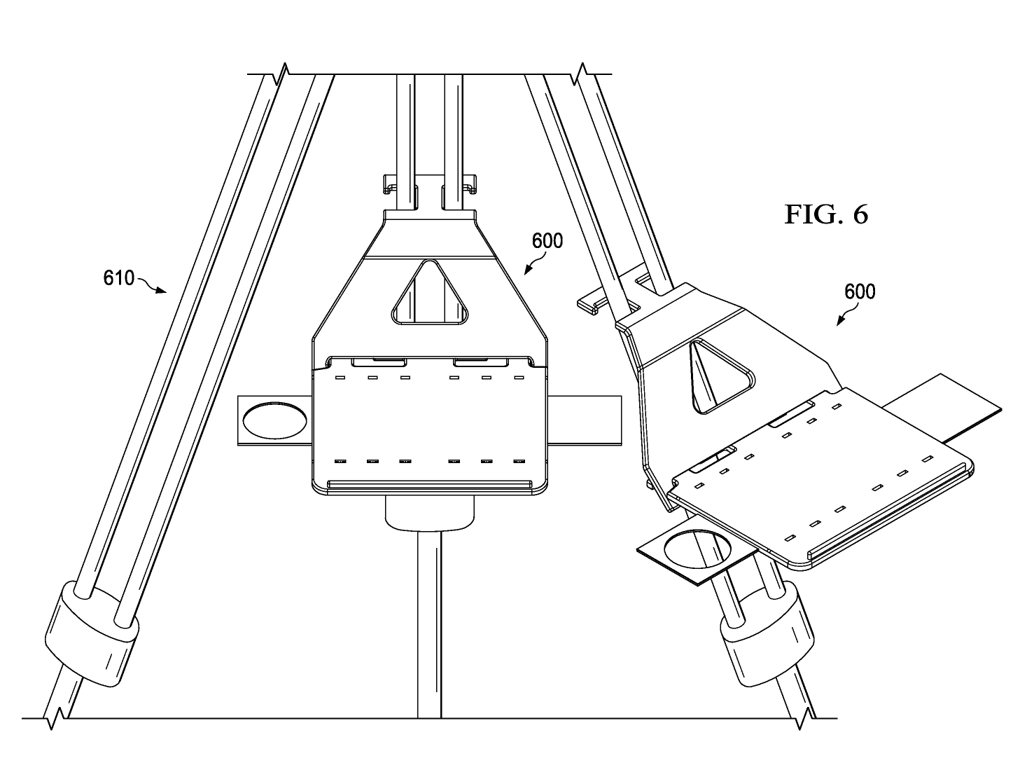

FIG. 6 illustrates the alternative embodiment of the stand attached to a tripod.

### DETAILED DESCRIPTION

The present disclosure is based, at least in part, on the acknowledgement that tripod users, whether they are an amateur/professional videographer, photographer, filmmaker, surveyor, coach shooting a game, as well as whether at home, in studio or on-location, have limited space and resources for supporting other much needed resources necessary for their task. Based at least in part on this acknowledgment, it is recognized that a stand that can couple to the tripod itself would greatly benefit tripod users.

The term tripod, as used herein, is intended to include all tripod designs, whether they include three, four, five, etc. supporting legs. The embodiments shown each depict only three supporting legs for any given tripod. This illustration, however, should not be used to limit the design to be used only with three supporting leg tripod designs, and in fact the design is equally applicable to four or more supporting leg tripod designs. Where the applicants intend to reference a specific design, such as wherein the applicants are only referring to a three supporting leg tripod design, the applicants will refer to that tripod as a three supporting leg tripod. Similar references would be made to four or more supporting leg tripod designs.

The term multi leg tripod, as used herein, is intended to reference tripod designs including more than one bracing feature for a given leg. For instance, FIG. 6 illustrates a multi leg tripod design. To be specific, FIG. 6 illustrates a double leg (e.g., two bracing feature) tripod design. Multi leg tripods are often designed and employed to support heavier electronic devices. Where the applicants intend to reference a specific design, such as wherein the applicants are only referring to a double bracing feature tripod design, the applicants will refer to that tripod as a double leg tripod. Similar references would be made to triple, quadruple, or more bracing leg tripod designs.

Turning to FIG. 1, illustrated is one embodiment of a stand 100 for use with a tripod. The stand 100 includes a first surface 110, in this embodiment, coupled to a second surface 160. The first and second surfaces 110, 160 may be removably coupled to one another, or alternatively rigidly coupled to one another. In the embodiment wherein the first and second surfaces 110, 160 are removably coupled to one another, the first and second surfaces 110, 160 may be easily decoupled for simple storage. In fact, in certain embodiments, the first and second surfaces 110, 160 can be decoupled and stored within a standard laptop bag, among other places.

In the illustrated embodiment, the first surface 110 is coupleable to the second surface 160 at an angle (θ) of greater than ninety degrees. In certain embodiments, the angle (θ) is selected based upon the degree at which the leg of a tripod approaches the surface it intends to rest upon, and the desire for the first surface 110 to be substantially level when deployed. The term substantially level, as used herein, means that the first surface 110 is within 25 degrees from level when deployed. In certain other embodiments, the angle (θ) is selected such that the first surface 110 is significantly level when deployed. The term significantly level, as used herein, means that the first surface 110 is within 10 degrees from level when deployed. Accordingly, in certain embodiments, the angle (θ) ranges from about 105 degrees to about 155 degrees. In certain other embodiments, the angle (θ) might range from about 120 degrees to about 140 degrees, or in another embodiment from about 125 degrees to about 135 degrees.

The first surface 110, in one embodiment, is intended to support resources that a user of a tripod might need easy access to. For example, the first surface 110 might be used to support a laptop, monitor, pad of paper, etc. Those skilled in the art understand the myriad of resources that might make use of the first surface 110.

The first surface 110, in the example embodiment, includes a lip 120. The lip 120, in this embodiment, is at an edge of the first surface 110 distal where the first and second surfaces 110, 160 couple to one another. As those skilled in the art appreciate, the lip 120 helps prevent any resource being used with the tripod from slipping from the first surface 110.

In the illustrated embodiment, the first surface 110 includes one or more extensions 130. The extensions 130, in one embodiment, slide into and out of the first surface 110. The extensions 130 may embody a variety of uses. For instance, the extensions 130, in one embodiment, may be configured as a cup holder. In this embodiment, an opening in the extension 130 may be configured to accept the base of a cup. In another embodiment, the extensions 130 may be configured as a mouse pad. In yet other embodiments, the extensions 130 may be configured as a writing pad, utility tray, etc. In the illustrated embodiment, the extensions 130 slide into and out of an edge of the first surface 110 perpendicular the edge where the lip 120 is located. Other embodiments exist, however, wherein the extensions 130 slide into and out of the same edge as the lip 120.

The second surface 160, in accordance with the disclosure, includes an opening 170 located therein. The opening 170, in this design, is configured to accept a neck of a tripod. The term neck, as used herein, means the portion of the tripod opposite the surface the tripod is configured to rest upon. In many embodiments, the neck of the tripod is the portion of the tripod that is most proximate the photography, videography, surveying equipment that the tripod is intended to support.

The opening 170 in the second surface 160 may include a variety of shapes and sizes. In certain embodiments, such as that shown in FIG. 1, the opening 170 comprises a triangle, for example as might beneficially be used with a three supporting leg tripod design. While the triangle illustrated in FIG. 1 is a equilateral triangle, in other embodiments, the triangle could be a right triangle. The triangle opening 170 of FIG. 1 is configured such that a pointed portion of the triangle is directed substantially away from the first surface 110 when the first and second surfaces 110, 160 are coupled.

Turning briefly to FIGS. 2A thru 2E, illustrated are different shapes for the opening 170. As illustrated in FIG. 2A, the opening 170 may comprise a triangle, but in this embodiment the pointed portion is directed substantially toward the first surface 110 when the first and second surfaces 110, 160 are coupled. As illustrated in FIG. 2B, the opening 170 may comprise a circle. As illustrated in FIGS. 2C and 2D, the opening 170 may comprise a pentagon and square, respectively. As illustrated in FIG. 2E, the opening 170 may comprise a self positioning star. The self positioning star design is configured to act as a ratchet type device. The self positioning star design allows the opening 170 to ratchet around the neck of the tripod in smaller increments than might be allowed for the other shapes, for example the triangle. While certain shapes have been given for the opening 170, other shapes (e.g., including a hexagon, an octagon, etc.) may be employed.

The stand 100 may additionally include other features 190. The features 190 may have a variety of sizes, shapes, locations, purposes, etc. In one embodiment, the stand 100 includes a feature 190 comprising a solar panel. In this embodiment, the solar panel might be integrated with, or into, the first or second surfaces 110, 160, and might be configured to power or charge electronic equipment of the user. In another embodiment, the stand 100 might include a feature 190 comprising a battery pack. In this embodiment, the battery pack might be integrated with, or into, the first or second surfaces 110, 160, and might be configured to power electronic equipment of the user. In yet another embodiment, the stand 100 might include a feature 190 comprising a connector or docking station. In this embodiment, the connector or docking station might be integrated with, or into, the first or second surfaces 110, 160, and might be configured to electronically couple multiple electronic devices of the user. For instance, a docking station configured to attach a monitor (e.g., including an ITouch, IPhone, IPad, etc.) to other videography or photography equipment, might be employed. Additionally, the feature 140 might comprise one or more speakers, a USB or firewire connector, memory, etc.

Turning to FIGS. 3A and 3B, illustrated are separated illustrations of the first surface 110 and second surface 160, respectively. As illustrated in FIG. 3A, the first surface 110 may include engaging features 310, 320. For instance, in the embodiment shown, the engaging feature 310 is a hook feature and the engaging feature 320 is a post feature. The first surface 110, in the embodiment shown, may further include a push pin 330.

As illustrated in FIG. 3B, the second surface 160 may include an accepting feature 360. Unique to one embodiment, the accepting feature 360 does not extend through the second surface 160 at an angle perpendicular to the major surface thereof. In this one embodiment, the accepting feature 360 extends into the second surface 160 at an angle (β). Turning briefly to FIG. 3C, illustrated is a cross-sectional view of the embodiment illustrated in FIG. 3B, taken through the line C-C, illustrating the angle (β) of the accepting feature 360. The angle (β), in one embodiment, ranges from about 105 degrees to about 155 degrees. In certain other embodiments, the angle (β) might range from about 120 degrees to about 140 degrees, or in another embodiment from about 125 degrees to about 135 degrees. In one example embodiment, the angle (β) and the angle (θ) are substantially similar. While this one embodiment illustrates that the accepting feature 360 includes the angled entrance, other embodiments exist wherein the accepting feature is perpendicular to the major surface of the second surface 160, resulting in the angle (β) being about 90 degrees.

The first and second surfaces 110, 160 illustrated in the embodiments of FIGS. 3A thru 3C, couple to one another using the engaging features 310, 320 and the accepting feature 360. For instance, the hook engaging feature 310 may first be positioned within the accepting feature 360. The post engaging feature 320 may then be positioned within the accepting feature 360, creating a snug fit. The push pin 330, in this embodiment, or another retaining member, may be used to keep the first and second surfaces 110, 160 engaged. As those skilled in the art appreciate, the angle (β) of the accepting feature 360 helps create the angle (θ) when the first and second surfaces 110, 160 are engaged.

The first surface 110 may additionally include a T feature 340. The T feature 340, in one embodiment, may allow the first surface 110 to be used without the second surface 160. For instance, the T feature 340 may allow the first surface 110 to be used as a work surface for a piece of luggage. For example, the T feature 340 of the first surface 110 may engage an extension handle on roller luggage, thereby providing a work surface on a piece of luggage. Accordingly, the stand 100 may not only be used as a work surface for a tripod, but may be disassembled and used as a work surface for a piece of luggage.

Turning briefly to FIG. 4, illustrated is an example embodiment wherein a stand 400, which may be similar to the stand 100 discussed with regard to FIGS. 1 thru 3C, is attached to a tripod 410. In the example embodiment of FIG. 4, the stand 400 is supporting a piece of electronic equipment, in this embodiment a laptop. As those skilled in the art appreciate, the stand 400 may support other devices, electronic and not.

Turning now to FIG. 5, illustrated is an alternative stand 500 manufactured in accordance with the principles of the disclosure. The stand 500, in this embodiment, includes a first surface 510 coupleable to a second surface 560. The first surface 510, in this embodiment, may be substantially similar to the first surface 110 in the embodiment of FIG. 1, and thus include many of the same features as the first surface 110. Nevertheless, other first surfaces 510 may bed used and remain within the purview of the disclosure.

The second surface 560, in contrast to the second surface 160 illustrated in FIG. 1, includes a first portion 563 and a second portion 568. In this embodiment, the first and second portions 563, 568 angle from one another by an angle (Q) of greater than ninety degrees. The first and second portions 563, 568 illustrated in FIG. 5 form a single piece. Nevertheless, other embodiments exist wherein the first and second portions 563, 568 are separate features that attachably engage one another.

In the illustrated embodiment of FIG. 5, the first portion 563 of the second surface 560 couples to the first surface 510 by an angle (θ) of greater than ninety degrees. Specifically, in the embodiment shown, an accepting feature in the first portion 563 accepts an engaging feature in the first surface 510 to couple the first and second surfaces 510, 560. In this embodiment, the angle (Ω) and the angle (θ) are alternate interior angles. In one example embodiment, the angle (Ω) and the angle (θ) are substantially equal, thus making the angle (Ω) and the angle (θ) substantially equal alternate interior angles. This substantially equal relationship between the two angles may be important to providing a substantially level first surface 510 when the stand 500 is positioned on a tripod.

In the embodiment of FIG. 5, the second portion 568 may additionally include a T portion 570. The T portion 570, in this embodiment, may be configured to engage a leg of a multi leg tripod design. For instance, the T portion 570 may engage two bracing features of a single leg of a tripod. In one embodiment, the T portion 570 is adjustable. For example, the T portion 570 may be adjustable to engage different thickness bracing features. In the example embodiment, a tightening knob is used to adjust the T portion 570 to accept different thickness bracing features.

Turning briefly to FIG. 6, illustrated is an example embodiment wherein a stand 600, which may be similar to the stand 500 discussed with regard to FIG. 5, is attached to a double leg tripod 610. In the example embodiment of FIG. 6, a T portion of the stand 600 is engaging two bracing features of the double leg tripod 610.

A stand, such as the stand illustrated in FIGS. 1 thru 6 may comprise a variety of different materials. For instance, in one embodiment, the stand comprises a strong carbon fiber material or heavy plastic. In an alternative embodiment, the stand comprises metal. Nevertheless, those skilled in the art understand that the stand may comprise any material within the scope of its intended purpose and remain within the purview of this disclosure. Given a particular material, those skilled in the art would easily understand how to manufacture a specific stand.

Those skilled in the art to which this application relates will appreciate that other and further additions, deletions, substitutions and modifications may be made to the described embodiments.

What is claimed is:

1. A stand for use with a tripod, comprising:
a first surface; and
a second surface coupleable to the first surface at an angle (θ) of greater than ninety degrees, wherein the second surface has an opening therein configured to accept a neck of a tripod.

2. The stand as recited in claim 1 wherein the opening is a triangle.

3. The stand as recited in claim 2 wherein a pointed portion of the triangle is directed substantially away from the first surface when the first and second surfaces are coupled.

4. The stand as recited in claim 2 wherein a pointed portion of the triangle is directed substantially toward the first surface when the first and second surfaces are coupled.

5. The stand as recited in claim 1 wherein the opening is selected from the group consisting of:
a circle;
a square;
a pentagon;
a hexagon;
an octagon; and
a self positioning star.

6. The stand as recited in claim 1 wherein the first and second surfaces are removably coupleable.

7. The stand as recited in claim 1 wherein the angle (θ) ranges from about 105 degrees to about 155 degrees.

8. The stand as recited in claim 7 wherein the angle (θ) ranges from about 125 degrees to about 135 degrees.

9. The stand as recited in claim 1 wherein the angle (θ) is such that the first surface is substantially level when the second surface is placed over a neck of a tripod.

10. The stand as recited in claim 1, further including an extension configured to slide into and out of the first surface.

11. The stand as recited in claim 10 wherein the extension is selected from the group consisting of:
a cup holder;
a mouse pad;
a writing pad; and
a utility tray.

12. The stand as recited in claim 1, further including a solar cell attachable to at least one of the first or second surfaces.

13. The stand as recited in claim 1, further including a hard drive or battery pack attachable to at least one of the first or second surfaces.

14. The stand as recited in claim 1, further including connectors or a docking station associated with at least one of the first or second surfaces, the connectors or docking station configured to couple to other electronic components.

15. The stand as recited in claim 1, further including one or more speakers attachable to at least one of the first or second surfaces.

16. A stand for use with a tripod, comprising:
a first surface; and
a second surface having a first portion and a second portion angled from one another by an angle (Ω) of greater than ninety degrees, the first portion coupleable to the first surface by an angle (θ) of greater than ninety degrees.

17. The stand as recited in claim 16 wherein the angle (Ω) and the angle (θ) are substantially equal.

18. The stand as recited in claim 16 wherein the second portion includes a T portion configured to engage a leg of a multi leg tripod design.

19. The stand as recited in claim 18 wherein the T portion is adjustable to engage different thickness bracing features of the multi leg tripod design.

20. The stand as recited in claim 16, further including an extension configured to slide into and out of the first surface.
